(19) United States
(12) Patent Application Publication
(10) Pub. No.: US 2026/0350433 A1
(43) Pub. Date: Nov. 5, 2026

(54) System and method for preprocessing data for training multiple AI models

(71) Applicant: Bank of America Corporation, Charlotte, NC (US)

(72) Inventors: Manu Kurian, Dallas, TX (US); Ana Maxim, Arlington, VA (US)

(21) Appl. No.: 19/198,321

(22) Filed: May 5, 2025

(51) Int. Cl. G06N 5/04; G06F 16/25

(52) U.S. Cl. CPC G06N 5/04; G06F 16/254

(57) ABSTRACT

A system includes a memory, and a processor coupled to the memory. The processor accesses a data lake including a number of subsystems. The processor aggregates data records from the number of subsystems. The processor constructs a consolidated set of data records by de-duplicating data records among the aggregated data records. The processor identifies a first artificial intelligence (AI) model and a second AI model to be trained. The processor constructs a first set of training data corresponding to the first AI model. The processor trains the first AI model using the first set of training data. The processor constructs a second training data set corresponding to the second AI model. The processor trains the second AI model using the second set of training data.

### TECHNICAL FIELD

The present disclosure relates generally to data processing, and more specifically, to preprocessing data for training multiple AI models.

### BACKGROUND

Artificial intelligence (AI) models require access to extremely large volumes of training data to achieve satisfactory performance, generalization, and robustness. In order to train such models effectively, the training data must not only be abundant in quantity but also suitably curated, structured, and formatted to match the specific requirements of the intended tasks corresponding to the models.

### SUMMARY

While many organizations collect and maintain large data repositories, often referred to as “data lakes,” these data lakes are typically designed for general-purpose storage and broad accessibility rather than for AI-specific training purposes. As a result, the data stored within a data lake is often unstructured, redundant, or heterogeneous in format. Data lakes may contain raw logs, documents, images, sensor data, and other types of information without the semantic organization or preprocessing that AI model training demands.

AI models are being widely used for various purposes. Different AI models may require different training data in different format. Training an AI mode with less relevant training data may result in wasting computing resources and time in the training stage. Also, the trained AI model may not be as accurate as desired. Thus, significant effort may be required to extract, clean, and customize data from a data lake before the data can be used effectively in training an AI model. This preparation step may involve complex workflows, substantial manual intervention, and specialized tooling, leading to increased costs, extended development timelines, and potential bottlenecks in AI model development. Therefore, there is a need for improved systems and methods for preprocessing data stored in large data lakes for efficient and effective training multiple AI models.

The system disclosed in the present application provides a technical solution to the problems discussed above. The disclosed system may effectively and efficiently preprocess data stored in large data lakes for training multiple AI models efficiently and effectively. The disclosed system may comprise a memory and a processor that is operably coupled to the memory. The processor may be configured to access a data lake comprising a plurality of subsystems. Each of the plurality of subsystems may contain data records. Types and formats of data records may vary. The processor may be configured to aggregate data records from the plurality of subsystems.

In particular embodiments, the processor may be configured to construct a consolidated set of data records by de-duplicating data records among the aggregated data records. To de-duplicate data records among the aggregated data records, the processor may be configured to determine whether a first data record is a subset of a second data record for each combination of the first data record and the second data record among the aggregated data records, and to remove the first data record from the aggregated data records when the first data record is determined to be the subset of the second data record.

In particular embodiments, the processor may be configured to identify a first artificial intelligence (AI) model and a second AI model to be trained. The processor may be configured to determine first characteristics of a first set of training data to be used for training the first AI model. The processor may be configured to determine second characteristics of a second set of training data to be used for training the second AI model.

In particular embodiments, the processor may be configured to construct the first set of training data corresponding to the first AI model. To construct the first set of training data, the processor may be configured to filter the consolidated set of data records to select first data records that are relevant to the first AI model, and to structure the first data records to make the first data records conform to a defined input format of the first AI model. To filter the consolidated set of data records to select the first data records that are relevant to the first AI model, the processor may be configured to initialize the selected first data records as an empty set of data records. Then, for each data record in the consolidated set of data records, the processor may be configured to determine whether the data record is relevant to the first AI model. The processor may be further configured to add the data record into the selected first data records when the data record is determined to be relevant to the first AI model. When the data record is added into the selected first data records, the processor may be configured to determine, for each data field of the data record, whether the data field is relevant to the first AI model. In particular embodiments, the processor may be configured to determine whether a data field is non-relevant to the first AI model when the data field is determined to contain non-conforming data type to the first AI model. The processor may be configured to remove a data field from the data record added into the selected first data records when the data field is determined to be non-relevant to the first AI model.

In particular embodiments, the first AI model may be a supervised learning mode. The processor may be configured to tag each record in the first set of training data with a ground truth label corresponding to the record.

In particular embodiments, the processor may be configured to train the first AI model using the first set of training data.

In particular embodiments, the processor may be configured to access a data profile conforming to the defined input format of the first AI model. The processor may be configured to obtain an inference result corresponding to the data profile by processing the data profile with the first AI model.

In particular embodiments, the processor may be configured to construct the second training data set corresponding to the second AI model. To construct the second set of training data, the processor may be configured to filter the consolidated set of data records to select second data records that are relevant to the second AI model, and to structure the second data records to make the second data records conform to a defined input format of the second AI model. To filter the consolidated set of data records to select the second data records that are relevant to the second AI model, the processor may be configured to initialize the selected second data records as an empty set of data records. Then, for each data record in the consolidated set of data records, the processor may be configured to determine whether the data record is relevant to the second AI model. The processor may be further configured to add the data record into the selected second data records when the data record is determined to be relevant to the second AI model. When the data record is added into the selected second data records, the processor may be configured to determine, for each data field of the data record, whether the data field is relevant to the second AI model. In particular embodiments, the processor may be configured to determine whether a data field is non-relevant to the second AI model when the data field is determined to contain a non-conforming data type to the second AI model. The processor may be configured to remove a data field from the data record added into the selected second data records when the data field is determined to be non-relevant to the second AI model. At least some of the second data records may be different from at least some of the first data records.

In particular embodiments, the processor may be configured to train the second AI model using the second set of training data.

In particular embodiments, the memory may be operable to store one or more rule-based algorithms. The processor may be configured to use the one or more rule-based algorithms to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

In particular embodiments, the processor may be configured to use one or more AI agents to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

Technical advantages of certain embodiments of this disclosure may include one or more of the following. The disclosed system and methods may construct a consolidated set of data records by aggregating and deduplicating data records from a plurality of subsystems of data lakes. The consolidated set of data records may comprise organized and unduplicated data records. Consequently, the organized and unduplicated data records may save computing time and resources for training a plurality of AI models. The disclosed system and methods may construct a targeted set of training data for a particular AI model by filtering and structuring data records. The targeted set of training data may result in efficient and effective training of the particular AI model with reduced consumption of computing time and resources without sacrificing the accuracy of the trained particular AI model. The disclosed system and methods may automate data preprocessing to construct a plurality of training data used for a plurality of respective AI models. With the automated data preprocessing, AI model developments may be expedited.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system where data records in a data lake are preprocessed to be training data for a plurality of AI models;

FIG. 2 illustrates a schematic diagram of a computer system, in accordance with certain aspects of the present disclosure; and

FIGS. 3A and 3B illustrate an example flowchart of a method for preprocessing data in a data lake for training multiple AI models, in accordance with one or more embodiments of the present disclosure.

### DETAILED DESCRIPTION

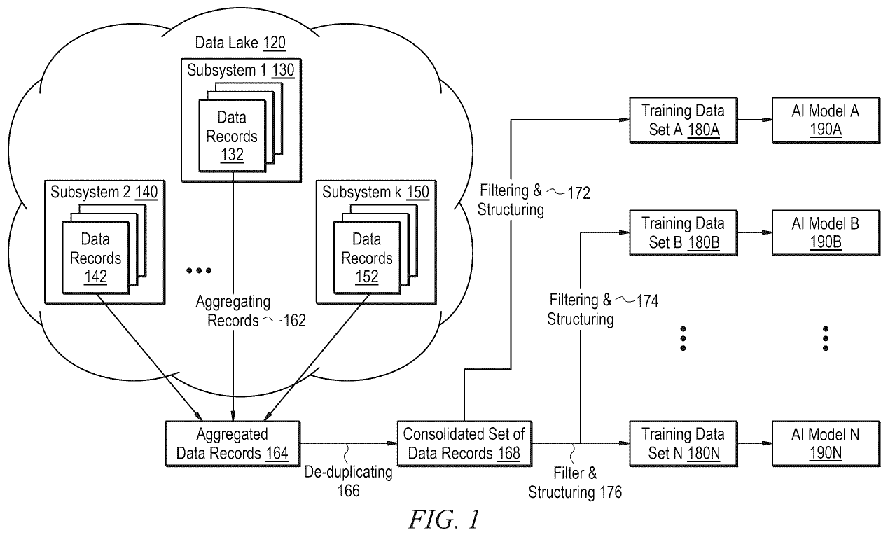

As described above, training AI models with well-preprocessed customized training data may conserve computing time and resources while the trained AI models produce accurate output. With reference to FIGS. 1-3, this disclosure presents various systems and methods to effectively and efficiently preprocess data stored in large data lakes for training a plurality of AI models.

### Example Embodiment of a System

FIG. 1 illustrates one embodiment of a system where data records in a data lake are preprocessed to be training data for a plurality of AI models. Data records in data lake 120 may be preprocessed to become a plurality of training data sets including 180A, 180B, and 180N corresponding to a plurality of AI models including 190A, 190B, and 190N.

### Example Data Lake

A data lake 120 may comprise a plurality of subsystems including subsystem 1130, subsystem 2 140, and subsystem k 150. In particular embodiments, each subsystem may comprise data records from a corresponding data source. For example, subsystem 1 130 may comprise data records 132 generated from business units within an entity. Subsystem 2 140 may comprise data records 142 collected from webpages associated with the entity. Subsystem k 150 may comprise data records 152 generated from interactions between the entity and third-party entities. In particular embodiments, each subsystem may comprise data records associated with corresponding functions. For example, subsystem 1 130 may comprise data records 132 associated with research and developments. Subsystem 2 140 may comprise data records 142 that are logs of previous occurred events. Subsystem k 150 may comprise data records 152 associated with contracts between entities. In particular embodiments, each subsystem may comprise data records created in a corresponding time range. subsystem 1 130 may comprise data records 132 generated in year 2023. Subsystem 2 140 may comprise data records 142 generated in the year 2024. Subsystem k 150 may comprise data records 152 generated in the year 2025. Although this disclosure describes particular structures of a data lake, this disclosure contemplates any suitable structures of a data lake.

### Consolidated Set of Data Records

At operation 162, data records 132, 142, and 152 from subsystem 1 130, subsystem 2 140, and subsystem k 150 may be aggregated into the aggregated data records 164. At operation 166, the aggregated data records 164 may be de-duplicated to construct a consolidated set of data records 168. While being de-duplicated, a first data record may be determined to be a subset of a second data record for each combination of the first data record and the second data record among the aggregated data records 164. When the first data record is determined to be a subset of the second data record, the first data record may be removed from the aggregated data records 164. The de-duplicated data records form the consolidated set of data records 168. Although this disclosure describes constructing a consolidated set of data records in a particular manner, this disclosure contemplates constructing a consolidated set of data records in any suitable manner.

### Constructing a Set of Training Data Corresponding to an AI Model

A plurality of AI models, including AI model A 190A, AI model B 190B, and AI model N 190N, may be identified to be trained. For each AI model to be trained, characteristics of a corresponding set of training data may be determined. Characteristics of a set of training data may comprise input data format for the AI model, contextual characteristics associated with the AI model, or any suitable characteristics for a set of training data.

Based on the determined characteristics, a set of training data corresponding to a particular AI model may be constructed. To construct the set of training data, the consolidated set of data records 168 may be filtered to select data records that are relevant to a particular AI model. The selected data records may be structured in such a way that conforms to a defined input format of the particular AI model. For example, for AI model A 190A, the consolidated set of data records 168 may be filtered and structured in operation 172 to construct training data set A 180A. For AI model B 190B, the consolidated set of data records 168 may be filtered and structured in operation 174 to construct training data set B 180B. For AI model N 190N, the consolidated set of data records 168 may be filtered and structured in operation 176 to construct training data set N 180N.

To filter the consolidated set of data records 168 to select the data records that are relevant to a particular AI model, an empty set of data records may be prepared as selected particular data records. Then, for each data record in the consolidated set of data records 168, the data record may be determined whether the data record is relevant to the particular AI model based on the determined characteristics of the set of training data corresponding to the particular AI model. When a data record is determined to be relevant to the particular AI model, the data record may be added into the selected particular data records. When the data record is added into the selected particular data records, each data field of the data record is determined whether the data field is relevant to the particular AI model. When the data field is determined to be non-relevant to the particular AI model, the data field may be removed from the data record added into the selected particular data records. When a data field is determined to contain non-conforming data type to the particular AI model, the data field may be determined to be non-relevant. Although this disclosure describes constructing a set of training data corresponding to an AI model in a particular manner, this disclosure contemplates constructing a set of training data corresponding to an AI model in any suitable manner.

### Computer System

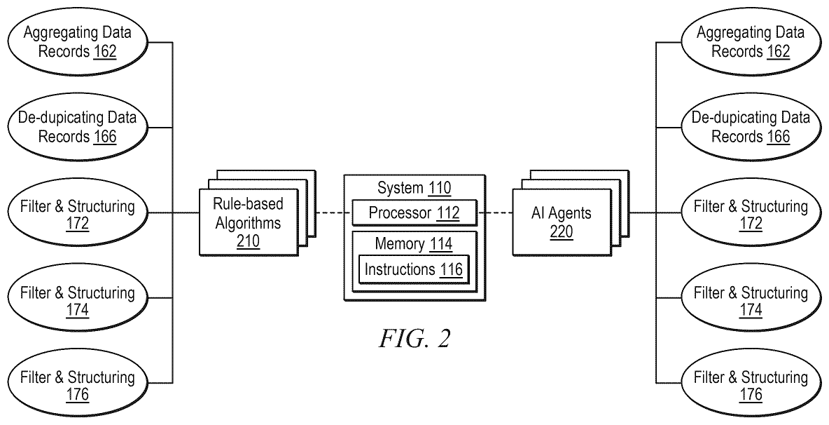

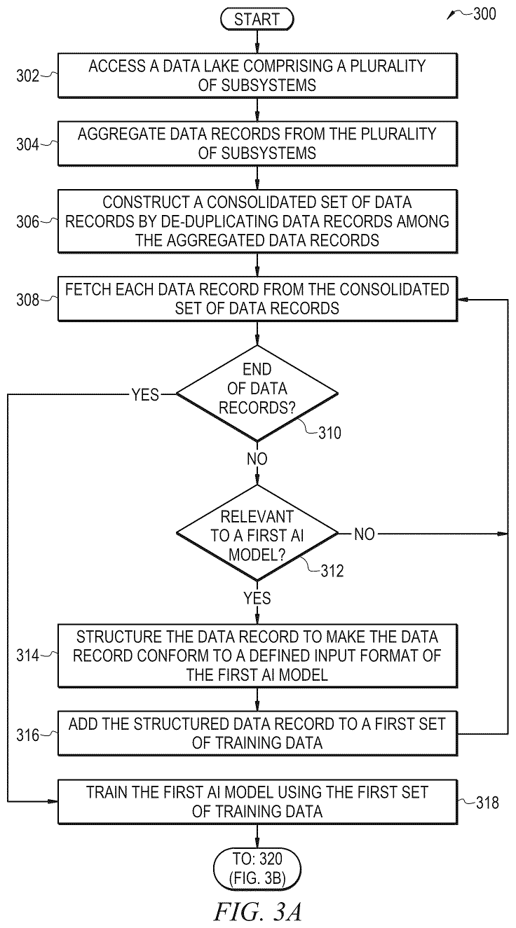

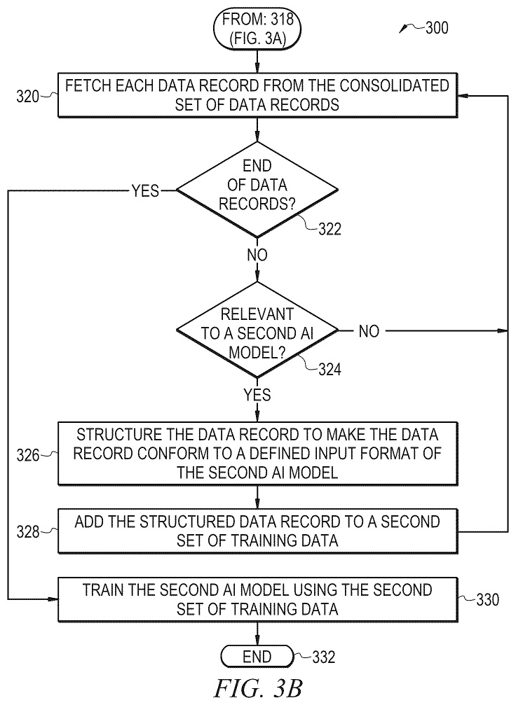

FIG. 2 illustrates a schematic diagram of a computer system, in accordance with certain aspects of the present disclosure. Computer system 110 may be generally any device that is configured to process data and communicate with devices, networks, systems, etc. Computer system 110 may be generally configured to perform operations described further below in conjunction with method 300 described in FIGS. 3A and 3B. In an embodiment, computer system 110 may comprise a processor 112 in signal communication with a memory 114.

Processor 112 comprises one or more processors operably coupled to the memory 114. Processor 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). Processor 112 may be a programmable logic device, a microcontroller, a microprocessor, or any suitable combination of the preceding. Processor 112 is communicatively coupled to and in signal communication with memory 114. Processor 112 is configured to process data. For example, processor 112 may be 8-bit, 16-bit, 32-bit, 64-bit or of any other suitable architecture. Processor 112 may include an arithmetic logic unit (ALU) for performing arithmetic and logic operations, processors register that supply operands to the ALU and store the results of ALU operations, and a control unit that fetches software instructions 116 from memory 114 and executes them by directing the coordinated operations of the ALU, registers and other components. Processor 112 is configured to implement various software instructions 116. For example, processor 112 is configured to execute software instructions 116 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

Memory 114 may be volatile or non-volatile and may comprise a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. Memory 114 is operable to store the software (e.g., rule-based algorithms 210), and/or any other data or software instructions 116.

Software instructions 116 may comprise any suitable set of instructions, logic, rules, or code operable to execute processor 112. Software instructions 116, when executed by processors 112, cause processor 112 to perform one or more functions described herein. For example, when software instructions 116 are executed, processor 112 executes rule-based algorithms 210 to aggregate data records from subsystems 130, 140, and 150 of the data lake 120, to de-duplicate data records among the aggregated data records 164, to filter and structure to construct training data set A 180A corresponding to AI model A 190A, to filter and structure to construct training data set B 180B corresponding to AI model B 190B, and to filter and structure to construct training data set N 180N corresponding to AI model N 190N. Software instructions 116, when executed by processors 112, cause processor 112 to use one or more AI agents 220 to aggregate data records from subsystems 130, 140, and 150 of the data lake 120, to de-duplicate data records among the aggregated data records 164, to filter and structure to construct training data set A 180A corresponding to AI model A 190A, to filter and structure to construct training data set B 180B corresponding to AI model B 190B, and to filter and structure to construct training data set N 180N corresponding to AI model N 190N. In particular embodiments, the AI agents 220 may be one or more AI models stored in memory 114. In particular embodiments, the AI agents 220 may be one or more AI models running on one or more remote systems. Although this disclosure describes a particular computer system that performs operations described herein, this disclosure contemplates any suitable computer systems that perform operations described herein.

### Operational Flow

In particular embodiments, processor 112 may be configured to access a data lake 120 comprising a plurality of subsystems 130, 140, and 150. Each of the plurality of subsystems may contain data records. Subsystem 1 130 may comprise data records 132. subsystem 2 140 may comprise data records 142. Subsystem k 150 may comprise data records 152. Types and formats of data records may vary. As an example, and not by way of limitation, data records 132 in subsystem 1 130 may contain English text. Data records 142 in subsystem 2 140 may contain images. Data records 152 in subsystem k 150 may contain video clips. Another example and not by way of limitations, data records 132, 142, and 152 may comprise a mixture of text, image, video, or audio data. Although this disclosure describes a particular data lake, this disclosure contemplates any suitable data lakes.

In particular embodiments, the processor 112 may be configured to aggregate data records from the plurality of subsystems 130, 140, and 150 to construct aggregated data records 164 at operation 162. In particular embodiments, processor 112 may be configured to construct a consolidated set of data records 168 by de-duplicating data records among the aggregated data records 164 at operation 166. To de-duplicate data records among the aggregated data records 164, processor 112 may be configured to determine whether a first data record is a subset of a second data record for each combination of the first data record and the second data record among the aggregated data records 164. Processor 112 may be further configured to remove the first data record from the aggregated data records 164 when the first data record is determined to be the subset of the second data record. The de-duplicated aggregated data records may be the consolidated set of data records 168. Although this disclosure describes constructing a consolidated set of data records in a particular manner, this disclosure contemplates constructing a consolidated set of data records in any suitable manner.

In particular embodiments, the processor 112 may be configured to identify AI model A 190A, AI model B 190B, and AI model N 190N to be trained. Processor 112 may be configured to determine characteristics of training data set A 180A corresponding to AI model A 190A. The processor 112 may be configured to determine characteristics of training data set B 180B corresponding to AI model B 190B. Likewise, the processor 112 may be configured to determine characteristics of training data set N 180N corresponding to AI model N 190N. Characteristics of a set of training data may comprise input data format for the AI model, contextual characteristics associated with the AI model, or any suitable characteristics for a set of training data. Although this disclosure describes identifying an AI model and determining characteristics of a set of training data corresponding to the AI model in a particular manner, this disclosure contemplates identifying an AI model and determining characteristics of a set of training data corresponding to the AI model in any suitable manner.

In particular embodiments, the processor 112 may be configured to construct training data set A 180A corresponding to AI model A 190A. To construct training data set A 180A, at operation 172, the processor 112 may be configured to filter the consolidated set of data records 168 to select first data records that are relevant to AI model A 190A based on the determined characteristics of training data set A 180A, and to structure the first data records to make the first data records conform to a defined input format of AI model A 190A based on the determined characteristics of training data set A 180A.

To filter the consolidated set of data records 168 to select particular data records that are relevant to a particular AI model, the processor 112 may be configured to initialize the selected particular data records as an empty set of data records. Then, for each data record in the consolidated set of data records 168, the processor 112 may be configured to determine whether the data record is relevant to the particular AI model. Processor 112 may be further configured to add the data record into the selected particular data records when the data record is determined to be relevant to the particular AI model. When the data record is added into the selected particular data records, the processor 112 may be configured to determine, for each data field of the data record, whether the data field is relevant to the particular AI model. In particular embodiments, processor 112 may be configured to determine whether a data field is non-relevant to the particular AI model when the data field is determined to contain a non-conforming data type to the particular AI model. Processor 112 may be configured to remove a data field from the data record added into the selected particular data records when the data field is determined to be non-relevant to the particular AI model. For example, a data field containing one or more video clips may be determined to be non-relevant to a large language model (LLM). Thus, the data field containing the one or more video clips may be removed from a data record that is added to the selected data records for the LLM. Although this disclosure describes filtering and structuring data records to construct a set of training data corresponding to a particular AI model in a particular manner, this disclosure contemplates filtering and structuring data records to construct a set of training data corresponding to a particular AI model in any suitable manner.

As an example, and not by way of limitation, AI model A 190A may be a supervised learning mode. Processor 112 may be configured to tag each record in the training data set A 180A corresponding to AI model A 190A with a ground truth label corresponding to the record. For example, AI model A 190A may be a classification model. For another example, AI model A 190A may be a regression model. Although this disclosure describes tagging data records in a set of training data corresponding to a supervised learning model in a particular manner, this disclosure contemplates tagging data records in a set of training data corresponding to a supervised learning model in any suitable manner.

In particular embodiments, the processor 112 may be configured to cause AI model A 190A to be trained using training data set A 180A. In particular embodiments, AI model A 190A may be trained until a condition to finish the training is satisfied. For example, AI model A 190A may be trained for a predetermined number of epochs. For another example, AI model A 190A may be trained until a corresponding loss function does not decrease considerably between epochs. For yet another example, AI model A 190A may be trained until a validation loss starts increasing. Although this disclosure describes training an AI model using a corresponding set of training data in a particular manner, this disclosure contemplates training an AI model using a corresponding set of training data in any suitable manner.

In particular embodiments, processor 112 may be configured to access a data profile conforming to the defined input format of AI model A 190A. Processor 112 may be configured to obtain an inference result corresponding to the data profile by processing the data profile with AI model A 190A. Although this disclosure describes obtaining an inference result using an AI model in a particular manner, this disclosure contemplates obtaining an inference result using an AI model in any suitable manner.

In particular embodiments, the processor 112 may be configured to construct training data set B 180B corresponding to AI model B 190B. To construct training data set B 180B, at operation 174, the processor 112 may be configured to filter the consolidated set of data records 168 to select second data records that are relevant to AI model B 190B based on the determined characteristics of training data set B 180B, and to structure the second data records to make the second data records conform to a defined input format of AI model B 190B based on the determined characteristics of training data set B 180B.

As an example, and not by way of limitation, AI model B 190B may be an unsupervised learning mode. For example, AI model B 190B may be an LLM. For another example, AI model B 190B may be a reinforcement learning (RL) model. Although this disclosure describes particular unsupervised learning models, this disclosure contemplates any suitable unsupervised learning models.

In particular embodiments, the processor 112 may be configured to cause AI model B 190B to be trained using training data set B 180B. In particular embodiments, the processor 112 may be configured to access a data profile conforming to the defined input format of AI model B 190B. Processor 112 may be configured to obtain an inference result corresponding to the data profile by processing the data profile with AI model B 190B.

In particular embodiments, the processor 112 may be configured to construct training data set N 180N corresponding to AI model N 190N. To construct training data set N 180N, at operation 176, the processor 112 may be configured to filter the consolidated set of data records 168 to select third data records that are relevant to AI model N 190N based on the determined characteristics of training data set N 180N, and to structure the third data records to make the third data records conform to a defined input format of AI model N 190N based on the determined characteristics of training data set N 180N.

In particular embodiments, the processor 112 may be configured to cause AI model N 190N to be trained using training data set N 180N. In particular embodiments, the processor 112 may be configured to access a data profile conforming to the defined input format of AI model N 190N. Processor 112 may be configured to obtain an inference result corresponding to the data profile by processing the data profile with AI model N 190N.

In particular embodiments, memory 114 may be operable to store one or more rule-based algorithms 210. The processor 112 may be configured to use the one or more rule-based algorithms 210 to aggregate the data records from the plurality of subsystems at operation 162, to de-duplicate the data records among the aggregated data records 164 at operation 166, to construct training data set A 180A corresponding to AI model A 190A at operation 172 by filtering the consolidated set of data records 168 to select first data records that are relevant to AI model A 190A and by structuring the first data records to make the first data records conform to the defined input format of AI model A 190A, to construct training data set B 180B corresponding to AI model B 190B at operation 174 by filtering the consolidated set of data records 168 to select second data records that are relevant to AI model B 190B and by structuring the second data records to make the second data records conform to the defined input format of AI model B 190B, to construct training data set N 180N corresponding to AI model N 190N at operation 176 by filtering the consolidated set of data records 168 to select third data records that are relevant to AI model N 190N and by structuring the first data records to make the first data records conform to the defined input format of AI model N 190N.

In particular embodiments, the processor 112 may be configured to use one or more AI agents 220 to aggregate the data records from the plurality of subsystems at operation 162, to de-duplicate the data records among the aggregated data records 164 at operation 166, to construct training data set A 180A corresponding to AI model A 190A at operation 172 by filtering the consolidated set of data records 168 to select first data records that are relevant to AI model A 190A and by structuring the first data records to make the first data records conform to the defined input format of AI model A 190A, to construct training data set B 180B corresponding to AI model B 190B at operation 174 by filtering the consolidated set of data records 168 to select second data records that are relevant to AI model B 190B and by structuring the second data records to make the second data records conform to the defined input format of AI model B 190B, to construct training data set N 180N corresponding to AI model N 190N at operation 176 by filtering the consolidated set of data records 168 to select third data records that are relevant to AI model N 190N and by structuring the first data records to make the first data records conform to the defined input format of AI model N 190N. In particular embodiments, the AI agents 220 may be one or more AI models stored in memory 114. In particular embodiments, the AI agents 220 may be one or more AI models running on one or more remote systems.

### Example Method for Preprocessing Data for Training a Plurality of AI Models

FIGS. 3A and 3B illustrate an example flowchart of a method 300 for preprocessing data in a data lake for training multiple AI models, in accordance with one or more embodiments of the present disclosure. Modifications, additions, or omissions may be made to method 300. Method 300 may include more, fewer, or other operations. For example, operations may be performed in parallel or in any suitable order. While at times discussed as a system 110, or components thereof performing operations, any suitable system or components of the system may perform one or more operations of the method 300. For example, one or more operations of method 300 may be implemented, at least in part, in the form of software instructions (e.g., software instructions 116 of FIG. 2), stored on non-transitory, tangible, computer-readable media (e.g., memory 114 of FIG. 2) that when run by one or more processors (e.g., processor 112 of FIG. 2) may cause the one or more processors to perform operations 302-336.

After starting, at operation 302, system 110 may access data lake 120, comprising a plurality of subsystems 130, 140, and 150. Each of the plurality of subsystems 130, 140, and 150 may contain data records 132, 142, and 152. The types and formats of data records may vary.

At operation 304, system 110 may aggregate data records from the plurality of subsystems 130, 140, and 150.

At operation 306, system 110 may construct a consolidated set of data records 168 by de-duplicating data records among the aggregated data records 164. To de-duplicate data records among the aggregated data records 164, the system 110 may determine whether a first data record is a subset of a second data record for each combination of the first data record and the second data record among the aggregated data records 164, and to remove the first data record from the aggregated data records 164 when the first data record is determined to be the subset of the second data record.

At operation 308, system 110 may fetch a data record from the consolidated set of data records 168. At operation 310, system 110 may determine whether an end of data records is reached in the consolidated set of data records 168. When the system 110 determines that the end of data records is reached, the method 300 proceeds to operation 318. When the system 110 determines that the end of data records has not been reached in the consolidated set of data records 168, the method 300 proceeds to operation 312, where the system 110 may determine whether the data record fetched at operation 308 is relevant to a first AI model. When the system 110 determines that the data record is non-relevant to the first AI model, method 300 proceeds back to operation 308, where the system 110 may fetch a next data record from the consolidated set of data records 168. When system 110 determines that the data record is relevant to the first AI model, method 300 proceeds to operation 314, where system 110 may structure the data record to make the data record conform to a defined input format of the first AI model. As a part of structuring the data record, system 110 may determine whether each data field of the data record is relevant to the first AI model. System 110 may remove a data field from the data record when the data field is determined to be non-relevant to the first AI model. In particular embodiments, the system 110 may determine that a data field is non-relevant to the first AI model when the data field is determined to contain a non-conforming data type to the first AI model.

At operation 316, the system 110 may add the structured data record to a first set of training data corresponding to the first AI model. After operation 316, method 300 proceeds back to operation 308, where system 110 may fetch a next data record from the consolidated set of data records 168.

At operation 318, system 110 may train the first AI model using the first set of training data.

At operation 320, system 110 may fetch a data record from the consolidated set of data records 168. At operation 322, system 110 may determine whether an end of data records is reached in the consolidated set of data records 168. When system 110 determines that the end of data records is reached, method 300 proceeds to operation 330. When the system 110 determines that the end of data records has not been reached in the consolidated set of data records 168, the method 300 proceeds to operation 324, where the system 110 may determine whether the data record fetched at operation 320 is relevant to a second AI model. When the system 110 determines that the data record is non-relevant to the second AI model, method 300 proceeds back to operation 320, where system 110 may fetch a next data record from the consolidated set of data records 168. When system 110 determines that the data record is relevant to the second AI model, method 300 proceeds to operation 326, where system 110 may structure the data record to make the data record conform to a defined input format of the second AI model. As a part of structuring the data record, system 110 may determine whether each data field of the data record is relevant to the second AI model. System 110 may remove a data field from the data record when the data field is determined to be non-relevant to the second AI model. In particular embodiments, system 110 may determine that a data field is non-relevant to the second AI model when the data field is determined to contain a non-conforming data type to the second AI model.

At operation 328, system 110 may add the structured data record to a second set of training data corresponding to the second AI model. After operation 328, method 300 proceeds back to operation 320, where the system 110 may fetch a next data record from the consolidated set of data records 168.

At operation 330, system 110 may train the second AI model using the second set of training data.

Method 300 then ends at operation 332.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory; and
a processor, operably coupled to the memory, and configured to:
access a data lake comprising a plurality of subsystems, wherein each of the plurality of subsystems contains data records, and wherein types and formats of data records vary;
aggregate data records from the plurality of subsystems;
construct a consolidated set of data records by de-duplicating data records among the aggregated data records;
identify a first artificial intelligence (AI) model and a second AI model to be trained;
construct a first set of training data corresponding to the first AI model, wherein constructing the first set of training data comprises:
filtering the consolidated set of data records to select first data records that are relevant to the first AI model; and
structuring the first data records to make the first data records conform to a defined input format of the first AI model;
train the first AI model using the first set of training data;
construct a second training data set corresponding to the second AI model, wherein constructing the second set of training data comprises:
filtering the consolidated set of data records to select second data records that are relevant to the second AI model, wherein at least some of the second data records are different from at least some of the first data records; and
structuring the second data records to make the second data records conform to a defined input format of the second AI model; and
train the second AI model using the second set of training data.

2. The system of claim 1, wherein the first AI model is a supervised learning mode, and wherein the processor is further configured to:
tag each record in the first set of training data with a ground truth label corresponding to the record.

3. The system of claim 1, wherein the processor is further configured to:
access a data profile conforming to the defined input format of the first AI model; and
obtain an inference result corresponding to the data profile by processing the data profile with the first AI model.

4. The system of claim 1, wherein de-duplicating data records among the aggregated data records comprises:
determining, for each combination of two data records, a first data record and a second data record, among the aggregated data records, whether the first data record is a subset of the second data record; and
removing, in response to a determination that the first data record is the subset of the second data record, the first data record from the aggregated data records.

5. The system of claim 1, wherein filtering the consolidated set of data records to select the first data records that are relevant to the first AI model comprises:
initializing the selected first data records as an empty set of data records;
adding, for each data record in the consolidated set of data records, the data record into the selected first data records when the data record is determined to be relevant to the first AI model;
removing data fields of the selected first data records that are determined to be non-relevant to the first AI model, wherein a data field containing a non-conforming data type to the first AI model is determined to be non-relevant to the first AI model.

6. The system of claim 1, wherein the memory is operable to store one or more rule-based algorithms, and wherein the processor is configured to use the one or more rule-based algorithms to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

7. The system of claim 1, wherein the processor is configured to use one or more AI agents to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

8. A method, comprising:
accessing a data lake comprising a plurality of subsystems, wherein each of the plurality of subsystems contains data records, and wherein types and formats of data records vary;
aggregating data records from the plurality of subsystems;
constructing a consolidated set of data records by de-duplicating data records among the aggregated data records;
identifying a first artificial intelligence (AI) model and a second AI model to be trained;
constructing a first set of training data corresponding to the first AI model, wherein constructing the first set of training data comprises:
filtering the consolidated set of data records to select first data records that are relevant to the first AI model; and
structuring the first data records to make the first data records conform to a defined input format of the first AI model;
training the first AI model using the first set of training data;
constructing a second training data set corresponding to the second AI model, wherein constructing the second set of training data comprises:
filtering the consolidated set of data records to select second data records that are relevant to the second AI model, wherein at least some of the second data records are different from at least some of the first data records; and
structuring the second data records to make the second data records conform to a defined input format of the second AI model; and
training the second AI model using the second set of training data.

9. The method of claim 8, wherein the first AI model is a supervised learning mode, further comprising:
tagging each record in the first set of training data with a ground truth label corresponding to the record.

10. The method of claim 8, further comprising:
accessing a data profile conforming to the defined input format of the first AI model; and
obtaining an inference result corresponding to the data profile by processing the data profile with the first AI model.

11. The method of claim 8, wherein de-duplicating data records among the aggregated data records comprises:
determining, for each combination of two data records, a first data record and a second data record, among the aggregated data records, whether the first data record is a subset of the second data record; and
removing, in response to a determination that the first data record is the subset of the second data record, the first data record from the aggregated data records.

12. The method of claim 8, wherein filtering the consolidated set of data records to select the first data records that are relevant to the first AI model comprises:
initializing the selected first data records as an empty set of data records;
adding, for each data record in the consolidated set of data records, the data record into the selected first data records when the data record is determined to be relevant to the first AI model; and
removing data fields of the selected first data records that are determined to be non-relevant to the first AI model, wherein a data field containing a non-conforming data type to the first AI model is determined to be non-relevant to the first AI model.

13. The method of claim 8, wherein one or more rule-based algorithms are used to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

14. The method of claim 8, wherein one or more AI agents are used to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.

15. A non-transitory computer-readable medium storing instructions that, when executed by one or more processors of a system, cause the one or more processors to:
access a data lake comprising a plurality of subsystems, wherein each of the plurality of subsystems contains data records, and wherein types and formats of data records vary;
aggregate data records from the plurality of subsystems;
construct a consolidated set of data records by de-duplicating data records among the aggregated data records;
identify a first artificial intelligence (AI) model and a second AI model to be trained;
construct a first set of training data corresponding to the first AI model, wherein constructing the first set of training data comprises:
filtering the consolidated set of data records to select first data records that are relevant to the first AI model; and
structuring the first data records to make the first data records conform to a defined input format of the first AI model;
train the first AI model using the first set of training data;
construct a second training data set corresponding to the second AI model, wherein constructing the second set of training data comprises:
filtering the consolidated set of data records to select second data records that are relevant to the second AI model, wherein at least some of the second data records are different from at least some of the first data records; and
structuring the second data records to make the second data records conform to a defined input format of the second AI model; and
train the second AI model using the second set of training data.

16. The non-transitory computer-readable medium of claim 15, wherein the first AI model is a supervised learning mode, and wherein the instructions further cause the one or more processors to:
tag each record in the first set of training data with a ground truth label corresponding to the record.

17. The non-transitory computer-readable medium of claim 15, wherein instructions further cause the one or more processors to:
access a data profile conforming to the defined input format of the first AI model; and
obtain an inference result corresponding to the data profile by processing the data profile with the first AI model.

18. The non-transitory computer-readable medium of claim 15, wherein de-duplicating data records among the aggregated data records comprises:
determining, for each combination of two data records, a first data record and a second data record, among the aggregated data records, whether the first data record is a subset of the second data record; and
removing, in response to a determination that the first data record is the subset of the second data record, the first data record from the aggregated data records.

19. The non-transitory computer-readable medium of claim 15, wherein filtering the consolidated set of data records to select the first data records that are relevant to the first AI model comprises:
initializing the selected first data records as an empty set of data records;
adding, for each data record in the consolidated set of data records, the data record into the selected first data records when the data record is determined to be relevant to the first AI model; and
removing data fields of the selected first data records that are determined to be non-relevant to the first AI model, wherein a data field containing a non-conforming data type to the first AI model is determined to be non-relevant to the first AI model.

20. The non-transitory computer-readable medium of claim 15, wherein the non-transitory computer-readable medium is operable to store one or more rule-based algorithms, and wherein the one or more processors are configured to use the one or more rule-based algorithms to aggregate the data records from the plurality of subsystems, to de-duplicate the data records among the aggregated data records, to filter the consolidated set of data records to select the first data records that are relevant to the first AI model, to structure the first data records to make the first data records conform to the defined input format of the first AI model, to filter the consolidated set of data records to select the second data records that are relevant to the second AI model, or to structure the second data records to make the second data records conform to the defined input format of the second AI model.
